(19) United States
(12) Patent Application Publication
(10) Pub. No.: US 2007/0251118 A1
(43) Pub. Date: Nov. 1, 2007

(54) Dryer and method for controlling the same

(75) Inventor: Young Jin Doh, Jinhae-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/785,257

(22) Filed: Apr. 16, 2007

(30) Foreign Application Priority Data
Apr. 17, 2006 (KR) 2006-34730

(51) Int. Cl. F26B 21/00; F26B 13/10

(52) U.S. Cl. 34/528; 34/524

(57) ABSTRACT

An object of the present invention is to provide a dryer and a method for controlling the same, in which a rotation speed of a drying drum is made to reach to a preset rotation speed regardless of a load of the drying object held in the drying drum. For this, the dryer includes a drying drum rotatably mounted in a body, a driving unit mounted to enable to vary a rotation speed of the drying drum, sensing means for sensing a load of the drying object in the drying drum, and a control unit for controlling the driving unit to vary a rotation speed of the driving unit proper to the load with reference to a sensing signal from the sensing means. For this, the method includes the steps of applying a drying course to start drying, sensing a load of a drying object with an electrode sensor after starting the drying course, and varying a rotation speed of the driving motor with the load sensed thus.

This application claims the benefit of the Patent Korean Application No. 10-2006-0034730, filed on Apr. 17, 2006, which is hereby incorporated by reference as if fully set forth herein.

### BACKGROUND OF THE INVENTION

1. Field of the Invention

The present invention relates to a dryer for drying washed laundry, more particularly, to a dryer in which a rotation speed of a drying drum is varied with a load of drying object for improving a drying performance.

2. Discussion of the Related Art

In general, in the dryers for drying a wet washed drying object (for an example, laundry) automatically, there are exhaust type dryers which draw in external air for drying the laundry, and condensing type dryers which dry laundry with circulating inside air from which the moisture is removed, condensed into water drops, and discharged from the dryer.

Of the dryers, a related art exhaust type dryer will be described with reference to the attached drawings, briefly.

Referring to FIG. 1, the related art exhaust type dryer is provided with a drying drum 20 rotatably mounted in a body 10 for drying the drying object therein, a drying drum supporter 60 in front of the drying drum 20 for rotatably supporting the drying drum 20, and a driving unit for rotating the drying drum 20.

In rear of the drying drum 20, there is a suction duct 30 in communication therewith for guiding hot air to an inside thereof, with a heater 35 at an inlet to the suction duct 30 for heating air drawn thereto. On a lower side of a front of the drying drum 20, there is a lint duct 40 having a filter 43 mounted thereto for filtering foreign matters, such as lint, from air from the drying drum 20.

At one side of the lint duct 40, there is a fan 45 for drawing air through the lint duct 40 and forced blowing of the air to an exhaust duct 15. The fan 45 is mounted in a fan housing 44 which is in communication with the lint duct 40.

The driving unit is provided with a driving motor 50 for rotating the fan 45 and the drying drum 20 at the same time, a pulley 53 at one side of the driving motor 50, and a belt 55 around the drying drum 20 for transmission of a rotating power thereto.

The fan 45 is connected to a driving shaft (not shown) of the driving motor 50 extended opposite to the pulley 53, such that the fan 45 is driven together with the driving motor 50.

In the foregoing exhaust type dryer, the drying drum 20 and the fan 45 which are connected with the belt 55 are rotated together as the driving motor 50 is rotated.

Moreover, as the fan 45 is rotated, external air is introduced into the suction duct 30, and therefrom to the drying drum 20 after heated as the air passes through the heater 35.

The hot air introduced into the drying drum 20 vaporizes moisture from the wet drying object to dry the drying object, is turned into low temperature, high humidity air, and is discharged to an outside of the dryer via the lint duct 40, the fan housing 44, the exhaust duct 15 in succession.

However, as described before, the driving motor 50 mounted to the related art dryer has an invariable rotation speed.

That is, regardless of a load of the drying object held in the drying drum 20, the driving motor 50 is designed to operate at a constant speed. However, the driving motor 50 is not operated at the constant speed actually, but has a rotation speed varied with the load of the drying object.

For an example, if the amount of the drying object in the drying drum 20 is small, a torque applied to the driving motor 50 through the drying drum 20 is reduced, to increase a rotation speed of the drying drum 20 greater than a preset rotation speed, and if the amount of the drying object in the drying drum 20 is great, a torque applied to the driving motor 50 through the drying drum 20 is increased, to reduce a rotation speed of the drying drum 20 smaller than the preset rotation speed.

Due to this, in a case the load of the drying object is small, the rotation speed of the drying drum 20 increases greater than the preset rotation speed, leading the laundry in the drying drum 20 to stick to an inside circumferential surface of the drying drum by centrifugal force, causing damage to the laundry and incomplete drying of the laundry at portions in contact with the inside circumferential surface of the drying drum.

Opposite to this, in a case the load of the drying object is great, the rotation speed of the drying drum 20 reduces smaller than the preset rotation speed, reducing the rotation speed of the fan that rotate together with the drying drum 20, to fail to supply enough hot air to an inside of the drying drum 20, which impairs the drying performance.

Consequently, laundry of fine fabric is liable to suffer from damage, and laundry of thick fabric is liable to fail to dry well, with poor drying efficiency.

### SUMMARY OF THE INVENTION

Accordingly, the present invention is directed to a dryer.

An object of the present invention is to provide a dryer and a method for controlling the same, in which a rotation speed of a drying drum is made to reach to a preset rotation speed regardless of a load of the drying object held in the drying drum.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dryer includes a drying drum rotatably mounted in a body, a driving unit mounted to enable to vary a rotation speed of the drying drum, sensing means sensing a load of the drying object in the drying drum, and a control unit controlling the driving unit to vary a rotation speed of the driving unit proper to the load with reference to a sensing signal from the sensing means.

The driving unit may include a BLAC motor of which rotation speed is variable, and a belt connected between the driving motor and the drying drum, for transmission of a rotation power from the driving motor to the drying drum.

The sensing means may be an Elect Rod Sensor which is formed such that the control unit can read a resistance value of the drying object when the drying object is placed between the two metal plates.

In another aspect of the present invention, a method for controlling a dryer having a motor of which speed can be varied by a control unit, includes the steps of applying a drying course to start drying, sensing a load of a drying object with an electrode sensor after starting the drying course, and varying a rotation speed of the driving motor with the load sensed thus.

The step of varying the rotation speed includes the step of progressing the drying such that the rotation speed of the driving motor reaches to a preset rotation speed by increasing the rotation speed of the driving motor in a case an amount of the drying object is great as a result of sensing with the electrode sensor.

The step of varying the rotation speed includes the step of progressing the drying such that the rotation speed of the driving motor reaches to a preset rotation speed by reducing the rotation speed of the driving motor in a case an amount of the drying object is small as a result of sensing with the electrode sensor.

The step of sensing a load of a drying object includes the steps of the control unit, calculating an average of resistance values from the electrode sensor, and comparing the average to a preset resistance value, to determine the load of the drying object.

The resistance values from the electrode sensor are resistance values of the electrode sensor measured within two minutes after starting of drying.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a longitudinal section illustrating a related art exhaust type dryer.

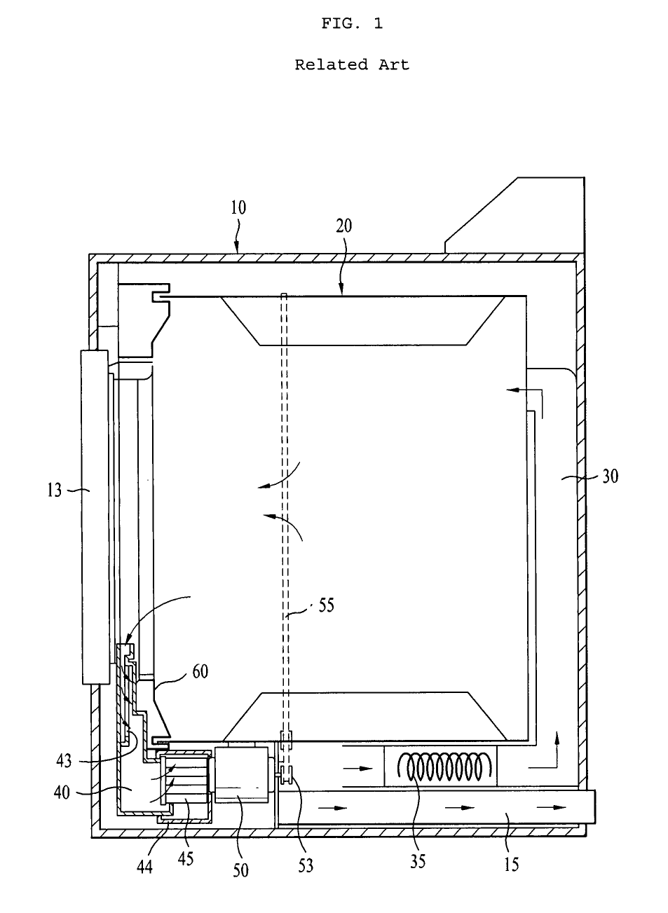

FIG. 2 is a longitudinal section illustrating an exhaust type dryer in accordance with a preferred embodiment of the present invention.

FIG. 3 is a block diagram illustrating a control system of a dryer in accordance with a preferred embodiment of the present invention.

FIG. 4 is a flow chart illustrating the steps of a method for controlling a dryer according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

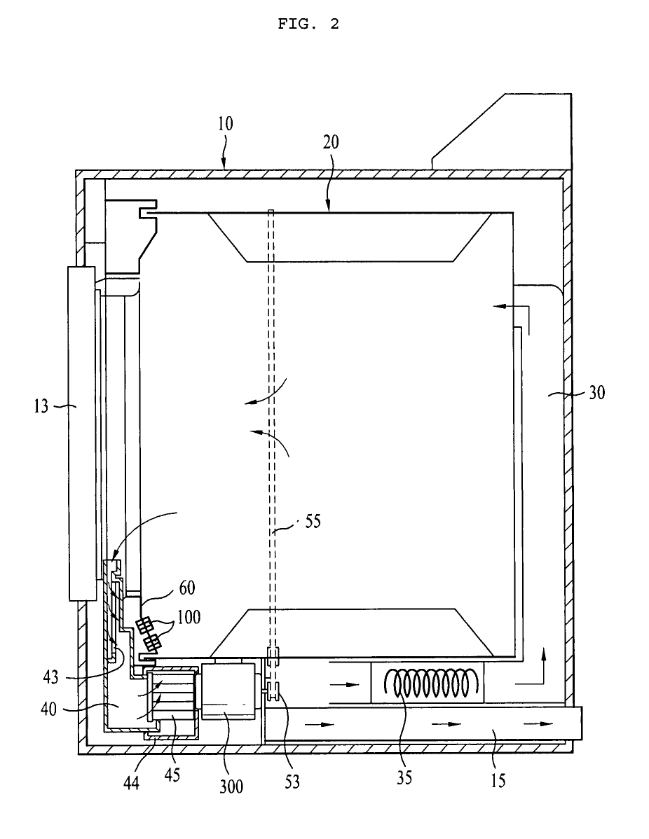

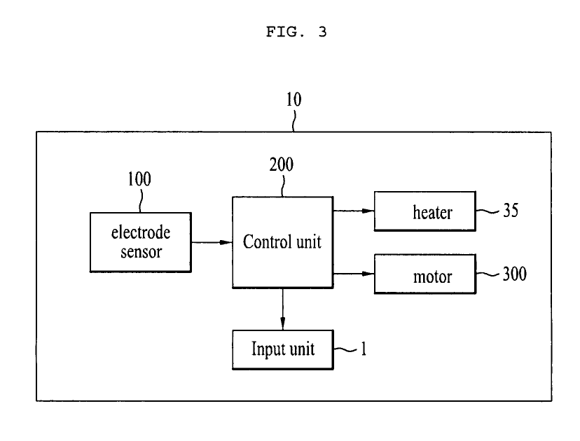

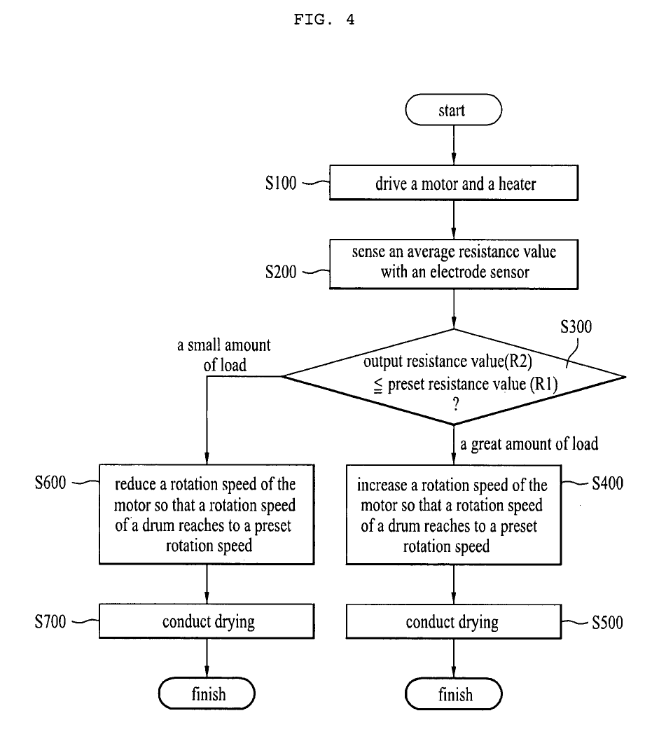

FIG. 2 is a longitudinal section illustrating an exhaust type dryer in accordance with a preferred embodiment of the present invention, FIG. 3 is a block diagram illustrating a control system of a dryer in accordance with a preferred embodiment of the present invention, and FIG. 4 is a flow chart illustrating the steps of a method for controlling a dryer according to the present invention.

Referring to FIG. 2 and 3, the dryer includes a drying drum 20 rotatably mounted in a body 10 for drying a drying object in the body 10, a drying drum supporter 60 on a front side of the drying drum 20 for rotatably supporting the drying drum 20, sensing means for sensing a load of the drying object in the drying drum 20, a driving unit for rotating the drying drum 20, and a control unit 200 for controlling the driving unit.

In rear of the drying drum 20, there is a suction duct 30 in communication therewith for guiding hot air to an inside thereof, with a heater 35 in the suction duct 30 for heating air drawn thereto. On a lower side of a front of the drying drum 20, there is a lint duct 40 having a filter 43 built therein for filtering lint and other foreign matters from air from the drying drum 20.

At one side of the lint duct 40, there is a fan 45 for drawing air through the lint duct 40 and forced blowing of the air to an exhaust duct 15. The fan 45 is mounted in a fan housing 44 which is in communication with the lint duct 40 and the exhaust duct 15.

The driving unit includes a driving motor 300 for rotating the fan 45 and the drying drum 20 at the same time, a pulley 53 at one side of the driving motor 300, and a belt 55 around the drying drum 20 for transmission of a rotating power thereto.

The fan 45 is connected to a driving shaft (not shown) extended opposite to the pulley 53 of the driving motor 300, such that the fan 45 is driven together with the driving motor 50 when the driving motor 300 is operated.

The exhaust duct 15 has one end extended to an outside the body 10 for leading air from the lint duct 40 blown by the fan 45 to the outside of the dryer.

In the meantime, on the front of the body 10, there is a door 13 for opening/closing the inside of the drying drum 20 to introduce/take out laundry to/from the inside of the drying drum 20.

The sensing means in the drying drum 20 senses the load of the drying object. Though a variety of things can be used as the sensing means, the embodiment shows an electrode sensor 100 used as the sensing means.

In more detail, the electrode sensor 100 is an Elec Rod Sensor (so called ‘Rod Humidity Sensor’) having two metal plates arranged parallel to each other, with wires connected thereto respectively, so that the control unit 200 can read a resistance value of the drying object when a circuit is closed as the drying object is placed between the metal plates, thereby detecting the load of the drying object.

That is, if the drying object containing moisture is brought into contact with the two metal plates at the same time, to close the circuit electrically, leading the drying object to act as a resistor in the circuit, the electrode sensor 100 measures the resistance value of the resistor, and the control unit reads the resistance value.

If the amount of the drying object is small, leading a contact area of the drying object to the electrode sensor small, the resistance value is sensed great inversely proportional to the contact area, and opposite to this, if the amount of the drying object is great, leading a contact area of the drying object to the electrode sensor great, the resistance value is sensed small inversely proportional to the contact area.

In the meantime, though the embodiment of the present invention suggests the driving motor 300 being a BLAC motor which can vary a speed of the drying drum 20 and the fan 45, the driving motor 300 may not be the BLAC motor, but may be anyone that can vary the speed of the drying drum 20 and the fan 45.

The variable speed driving motor 300 is used thus, so that the rotation speed of the drying drum 20 is reached to the preset rotation speed of the drying drum 20 by controlling the rotation speed of the driving motor 300 according to the load sensed as the resistance value of the electrode sensor 100.

For an example, as a result of sensing with the electrode sensor 100, if the amount of the drying object in the drying drum 20 is small (hereafter called as ‘small load’), since the load on the drying drum 20 is reduced, the drying drum 20 rotates faster than the preset rotation speed of 50-52 rpm.

In this instance, the rotation speed of the driving motor 300 is reduced by the control unit 200 so that the rotation speed of the drying drum 20 reaches to the preset rotation speed of 50-52 rpm.

Opposite to this, as a result of sensing with the electrode sensor 100, if the amount of the drying object in the drying drum 20 is great (hereafter called as ‘great load’), since the load on the drying drum 20 is increased, the drying drum 20 rotates slower than the preset rotation speed of 50-52 rpm.

In this instance, the rotation speed of the driving motor 300 is increased by the control unit 200 so that the rotation speed of the drying drum 20 reaches to the preset rotation speed of 50-52 rpm.

A method for controlling a rotation speed of the drying drum according to a load on the dryer will be described.

The method for controlling a dryer in accordance with a preferred embodiment of the present invention includes applying a drying course to start drying, sensing a load of a drying object with an electrode sensor after starting of drying, and varying the rotation speed of the driving motor 300 with the load sensed thus.

If the amount of the drying object is great as a result of sensing with the electrode sensor 100, it is preferable that the rotation speed of the driving motor 300 is increased, so that the rotation speed of the drying drum 20 reaches to the preset rotation speed, and, if the amount of the drying object is small as a result of sensing with the electrode sensor 100, it is preferable that the rotation speed of the driving motor 300 is reduced, so that the rotation speed of the drying drum 20 reaches to the preset rotation speed.

A method for controlling a dryer will be described in more detail with reference to FIG. 4.

Power is applied to the dryer, and a drying object to be dried is introduced into a drying drum 20 of the dryer.

Then, user selects a desired drying operation with an input unit 1, to drive the driving motor 300 and the heater 35 (S100).

The drying operation is made as the drying drum 20 is rotated, and the drying object is brought into contact with the electrodes of the electrode sensor 100, continuously.

As such operation is repeated, a resistance value between the electrodes is sensed with the electrode sensor 100 (S200).

Then, resistance values measured a plurality of times with the electrode sensor 100 are transmitted to the control unit 200, and the control unit 200 calculates an average of the resistance values from the electrode sensor 100, and compares the average to a preset resistance value, to determine the load of the drying object (S300).

It is preferable that, in the step of determination after measurement of the resistance values with the electrode sensor 100, resistance values are used, which are measured with the electrode sensor 100 within two minutes after starting of the drying. This is because measuring an accurate load of the drying object is not possible as time goes by due to gradual drying of the drying object, which increases the resistance values.

Then, according to a result of determination of the load with reference to the resistance value of the electrode sensor 100, the control unit varies the rotation speed of the driving motor 300.

At first, if a signal of an output resistance value R2 of the electrode sensor 100 sensed smaller than or equal to the preset resistance value R1 is transmitted to the control unit 200 as a result of sensing with the electrode sensor 100, the control unit 200 determines that the amount of the drying object is great, and increases the rotation speed of the driving motor 300 until the rotation speed reaches to the preset rotation speed of 50-52 rpm (S400).

Then, if the rotation speed of the drying drum 20 is increased to reach to the preset rotation speed, the drying is finished after conducting the drying for a preset time period (S500).

Opposite to this, if a signal of an output resistance value R2 of the electrode sensor 100 sensed greater than the preset resistance value R1 is transmitted to the control unit 200 as a result of sensing with the electrode sensor 100, the control unit 200 determines that the amount of the drying object is small, and reduces the rotation speed of the driving motor 300 until the rotation speed reaches to the preset rotation speed of 50-52 rpm (S600).

Then, if the rotation speed of the drying drum 20 is reduced to reach to the preset rotation speed, the drying is finished after conducting the drying for a preset time period (S700).

As has been described, because the rotation speed of the driving drum varied with the load of the drying object during drying can be made to reach to the preset rotation speed of the drying drum by varying the rotation speed of the driving motor, the dryer of the present invention can protect the laundry and improves a drying performance.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

As has been described, the dryer and the method for controlling a dryer of the present invention have the following advantages.

First, because the drying is progressed at a preset rotation speed by varying the rotation speed of the drying drum with the load of the drying object with a variable speed driving motor, the drying performance can be improved.

Second, because the drying is progressed after an increased rotation speed of the drying drum is reduced to the preset rotation speed by using the driving motor if the amount of the drying object is small, the sticking of the laundry in the drying drum 20 to an inside circumferential surface of the drying drum and incomplete drying of the laundry can be prevented.

Third, because the drying is progressed after a reduced rotation speed of the drying drum is increased to the preset rotation speed by using the driving motor if the amount of the drying object is great, permitting smooth supply of the hot air into the drying drum, drop of the drying performance can be prevented.

What is claimed is:

1. A dryer comprising:
a drying drum rotatably mounted in a body;
a driving unit mounted to enable to vary a rotation speed of the drying drum;
sensing means sensing a load of the drying object in the drying drum; and
a control unit controlling the driving unit to vary a rotation speed of the driving unit proper to the load with reference to a sensing signal from the sensing means.

2. The dryer of claim 1, wherein the driving unit includes;
a BLAC motor of which rotation speed is variable, and
a belt connected between the driving motor and the drying drum, for transmission of a rotation power from the driving motor to the drying drum.

3. The dryer of claim 1, wherein the sensing means is an Elect Rod Sensor which is formed such that the control unit can read a resistance value of the drying object when the drying object is placed between the two metal plates.

4. A method for controlling a dryer having a motor of which speed can be varied by a control unit, comprising the steps of:
applying a drying course to start drying;
sensing a load of a drying object with an electrode sensor after starting the drying course; and
varying a rotation speed of the driving motor with the load sensed thus.

5. The method for controlling a dryer of claim 4, wherein the step of varying the rotation speed includes the step of progressing the drying such that the rotation speed of the driving motor reaches to a preset rotation speed by increasing the rotation speed of the driving motor in a case an amount of the drying object is great as a result of sensing with the electrode sensor.

6. The method for controlling a dryer of claim 4, wherein the step of varying the rotation speed includes the step of progressing the drying such that the rotation speed of the driving motor reaches to a preset rotation speed by reducing the rotation speed of the driving motor in a case an amount of the drying object is small as a result of sensing with the electrode sensor.

7. The method for controlling a dryer of claim 4,
wherein the step of sensing a load of a drying object includes the steps of the control unit,
calculating an average of resistance values from the electrode sensor, and
comparing the average to a preset resistance value, to determine the load of the drying object.

8. The method for controlling a dryer of claim 7, wherein the resistance values from the electrode sensor are resistance values of the electrode sensor measured within two minutes after starting of drying.
